(19) United States
(12) Patent Application Publication
(10) Pub. No.: US 2014/0286857 A1
(43) Pub. Date: Sep. 25, 2014

(54) METHODS OF PREPARING METAL CONTAINING INORGANIC ION EXCHANGERS

(71) Applicant: BASF CORPORATION, Florham Park, NJ (US)

(72) Inventors: Ahmad Dehestani, Westfield, NJ (US); Gerald Koermer, Basking Ridge, NJ (US); Mukta Rai, Marlboro, NJ (US)

(73) Assignee: BASF CORPORATION, Florham Park, NJ (US)

(21) Appl. No.: 14/208,521

(22) Filed: Mar. 13, 2014

Related U.S. Application Data
(60) Provisional application No. 61/804,161, filed on Mar. 21, 2013.

(51) Int. Cl. B01J 29/76; C25C 1/22; C25C 1/12; C25C 1/16; C25C 1/10; C25C 1/08

(52) U.S. Cl. CPC B01J 29/76; C25C 1/10; C25C 1/08; C25C 1/12; C25C 1/16; C25C 1/22
USPC 423/700; 205/560; 205/564; 205/572; 205/573; 205/587; 205/574; 205/602; 205/571

(57) ABSTRACT

A method of preparing a metal containing inorganic ion exchanger in an electrochemical cell is disclosed. In one embodiment, the method comprises: (a) adding the inorganic ion exchanger to the electrochemical cell, wherein the electrochemical cell comprises a conductive electrolyte solution having a liquid phase and a solid phase; (b) depositing metal ions electrochemically into the liquid phase; (c) allowing the metal ions to deposit onto the inorganic ion exchanger during an electrochemical reaction to obtain a metal containing inorganic ion exchanger; (d) collecting the solid phase comprising the metal containing inorganic ion exchanger obtained in step (c); (e) removing remaining metal ions from the liquid phase; and (f) obtaining a substantially metal free liquid phase.

### CROSS-REFERENCE TO RELATED APPLICATIONS

This application claims priority to U.S. Provisional Patent Application No. 61/804,161, filed on Mar. 21, 2013, which is incorporated herein by reference in its entirety.

### FIELD OF THE INVENTION

Methods of preparing metal containing inorganic ion exchangers in electrochemical cells are disclosed in this application. Methods of obtaining substantially metal free liquid phases when preparing metal containing inorganic ion exchangers in electrochemical cells are also disclosed in this application. Catalysts comprising metal containing inorganic ion exchangers are further disclosed in this application.

### BACKGROUND OF THE INVENTION

U.S. Publication 2008/0226545 discusses copper chabazite (hereinafter “CHA”) catalysts and their application in exhaust gas systems such as those designed to reduce nitrogen oxides. In specific embodiments, U.S. Publication 2008/0226545 discloses Cu CHA catalysts which exhibit improved NH₃ Selective Catalytic Reduction (hereinafter “SCR”) of NOx. One embodiment of U.S. Publication 2008/0226545 relates to a catalyst comprising a zeolite having the CHA crystal structure and a mole ratio of silica to alumina greater than about 15 and an atomic ratio of copper to aluminum exceeding about 0.25. In some embodiments of U.S. Publication 2008/0226545 the catalyst is deposited on a honeycomb substrate. In one or more embodiments of U.S. Publication 2008/0226545, the honeycomb substrate comprises a wall flow substrate. In other embodiments of U.S. Publication 2008/0226545, the honeycomb substrate comprises a flow through substrate. In certain embodiments of U.S. Publication 2008/0226545, at least a portion of the flow through substrate is coated with CuCHA adapted to reduce oxides of nitrogen contained in a gas stream flowing through the substrate. In a specific embodiment of U.S. Publication 2008/0226545, at least a portion of the flow through substrate is coated with Pt and Cu CHA adapted to oxidize ammonia in the exhaust gas stream.

Many catalytic processes use metal exchanged zeolites as the active catalyst. One example is NH₃ SCR, which is used for removing NOx from diesel exhaust emissions. Traditionally copper ion exchange in making iron and copper exchanged zeolites is completed by treating zeolites with a concentrated solution of a metal salt (e.g., copper nitrate, acetate etc).

Metal exchanged zeolites and molecular sieves are important catalysts in many applications such as NH₃ SCR. As provided in WO 2008/106519, traditional solution phase ion exchange with soluble metal salts is the most common method for preparing metal exchanged zeolites or molecular sieves. Alternatively, solid state ion exchange methods (Andreas Jentys et al., J. Chem. Soc., Faraday Trans., 1997, 93, 4091-4094) have been developed but their utility is limited. In addition, so called “one pot” methods where the metal ion of choice is included into the sieve synthesis medium have also been used to produce metal exchanged zeolites. “One pot” methods do not work as well as methods with multiple steps due to many deficiencies in the “one pot” method including but not limited to imprecise control of metal levels, metal ion incompatibility with the synthesis medium or process conditions, etc.

The solution phase process typically involves treating an aqueous slurry of the sodium or ammonium form sieve with a concentrated solution of a soluble metal salt (e.g., sulfate, acetate, and nitrate) at moderate temperatures for a period of time. The sieve is then filtered and washed to remove excess metal ions. Often metal ions remain in the ion exchange liquor or in the wash water. Often the costs of the metal salts and waste stream treatment can be significant.

The disclosure hereinbelow outlines an alternative electrochemical method for preparing metal exchanged inorganic ion exchanger materials. For brevity, while the remainder of the patent application primarily discusses “inorganic ion exchanger(s)” and “zeolite(s)”, it will be understood that the use of the term “inorganic ion exchanger(s)” encompasses “molecular sieve(s)”, “zeolite(s)”, “mesoporous material(s)”, and “amorphous materials” in this patent application.

The disclosed methods can reduce the cost of ion exchange onto molecular sieves by eliminating the cost of metal salts and reducing/eliminating the cost of metal containing waste stream disposal. The methods can be widely applicable to metals that are easily oxidizable/reducible.

The disclosure hereinbelow describes a novel method for introducing metal ions into zeolites and molecular sieves. This method involves electrochemical techniques that can obviate the need for metal salts and may reduce the wastewater treatment needs. As a result, this technology can significantly reduce ion exchange costs and waste disposal/environmental costs.

### SUMMARY OF THE INVENTION

According to one embodiment, a method of preparing a metal containing inorganic ion exchanger in an electrochemical cell is disclosed. The method comprises: (a) adding the inorganic ion exchanger to the electrochemical cell, wherein the electrochemical cell comprises a conductive electrolyte solution having a liquid phase and a solid phase (b) depositing metal ions electrochemically into the liquid phase; (c) allowing the metal ions to deposit onto the inorganic ion exchanger during an electrochemical reaction to obtain a metal containing inorganic ion exchanger; (d) collecting the solid phase comprising the metal containing inorganic ion exchanger obtained in step (c); (e) removing remaining metal ions from the liquid phase; and (f) obtaining a substantially metal free liquid phase.

According to another embodiment, a method of obtaining a substantially metal free liquid phase when preparing a metal containing inorganic ion exchanger in an electrochemical cell is disclosed. The method comprises: (a) adding the inorganic ion exchanger to the electrochemical cell, wherein the electrochemical cell comprises a conductive electrolyte solution having a liquid phase and a solid phase; (b) depositing metal ions electrochemically into the liquid phase; (c) allowing the metal ions to deposit onto the inorganic ion exchanger during an electrochemical reaction to obtain metal containing inorganic ion exchanger; (d) collecting the solid phase comprising the metal containing inorganic ion exchanger obtained in step (c); (e) removing remaining metal ions from the liquid phase; and (f) obtaining a substantially metal free liquid phase.

According to yet another embodiment, a catalyst comprising a metal containing inorganic ion exchanger, wherein the metal containing inorganic ion exchanger is prepared in an electrochemical cell, and wherein the method of preparing the metal containing inorganic ion exchanger comprises: (a) adding the inorganic ion exchanger to the electrochemical cell, wherein the electrochemical cell comprises a conductive electrolyte solution having a liquid phase and a solid phase; (b) depositing metal ions electrochemically into the liquid phase; (c) allowing the metal ions to deposit onto the inorganic ion exchanger during an electrochemical reaction to obtain metal containing inorganic ion exchanger; (d) collecting the solid phase comprising the metal containing inorganic ion exchanger obtained in step (c); (e) removing remaining metal ions from the liquid phase; and (f) obtaining a substantially metal free liquid phase.

### BRIEF DESCRIPTION OF THE DRAWINGS

FIG. 1 is a schematic of an electrochemical cell.

FIG. 2 is a Pourbaix diagram of copper in acid and alkaline water at standard conditions.

FIG. 3 shows six photographs representing the visual cycle of electrochemistry ion exchange process—a. shows a cell with electrodes, water, and electrolyte before zeolite addition; b. shows a cell after zeolite addition; c. shows a cell after deposition of copper ions into solution; d. shows the filtered zeolite copper exchanged material; e. shows the mother liquid of the reaction returned to the cell and the leads are reversed; and f. shows the copper ions came out of solution and deposited back onto the copper foil.

FIG. 4 is a graphical representation of NH₃-SCR activity data generated for Cu exchanged SSZ-13 after steam aging at 850° C. for 6 hours.

FIG. 5 is a graphical representation of NH₃-SCR activity data generated for Cu exchanged SSZ-13 after steam (10%) aging at 850° C. for 6 hours in air.

### DETAILED DESCRIPTION OF THE INVENTION

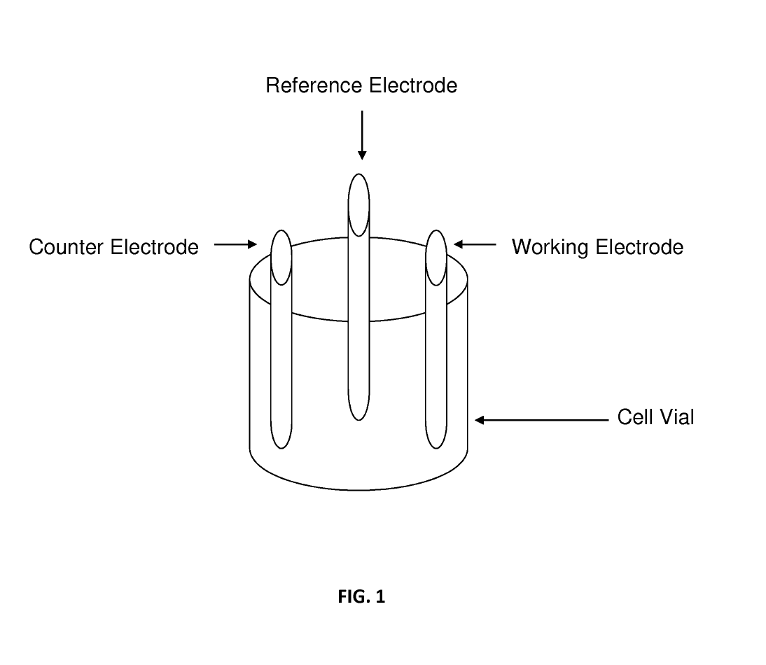

Bulk electrolysis is an electrochemical technique that allows deposition and removal of metals from a solution. It is a process that can involve the use of three electrodes (i.e., the working electrode, the counter electrode, and the reference electrode) and is controlled by either a potentiostat or a galvanostat. The working electrode is kept either at a constant current (amps) or potential (volts) and is monitored over time. The counter electrode is used to complete the half reaction of the electrochemical cell. FIG. 1 shows a general set up of the aforementioned apparatus used to carry out the bulk electrolysis.

The working electrode is the metal of interest (e.g., metallic copper or iron) and is held at a constant potential (volts). Current (amps) is monitored over time (seconds) by using a potentiostat. The counter electrode can be platinum gauze or reticulated vitreous carbon electrode. A quasi-reference electrode—Ag/AgCl to monitor the potential can be used. Alternatively, the quasi-reference electrode can be saturated calomel electrode. An aqueous slurry of the zeolite is contained in the electrochemical cell. Examples of various zeolites are provided hereinbelow.

For example, two half reactions during bulk electrolysis are shown below in equation 1 and 2.

Anode(working electrode): Cu(s)→2Cu²⁺+4e⁻ (1)

Cathode(counter electrode): 4H⁺+4e⁻→2H₂(g) (2)

The amount of metal ions (e.g., copper) that are deposited into solution by using a simplified version of Faraday's first law (see equation 3 hereinbelow) can be monitored. Once the metal ions from the metal electrode are in solution, they are picked up by the inorganic ion exchanger by a process of ion exchange.

$$m = \frac{1}{96 \text{,} 4485 ( C \cdot {mol}^{-} 1 )} \cdot \frac{QM}{n} \qquad ( 3 )$$

wherein,
m is the mass of the substance produced at the electrode (in grams),
Q is the total electric charge that passed through the solution (in coulombs),
n is the valence number of the substance as an ion in solution (electrons per ion),
M is the molar mass of the substance (in grams per mole).

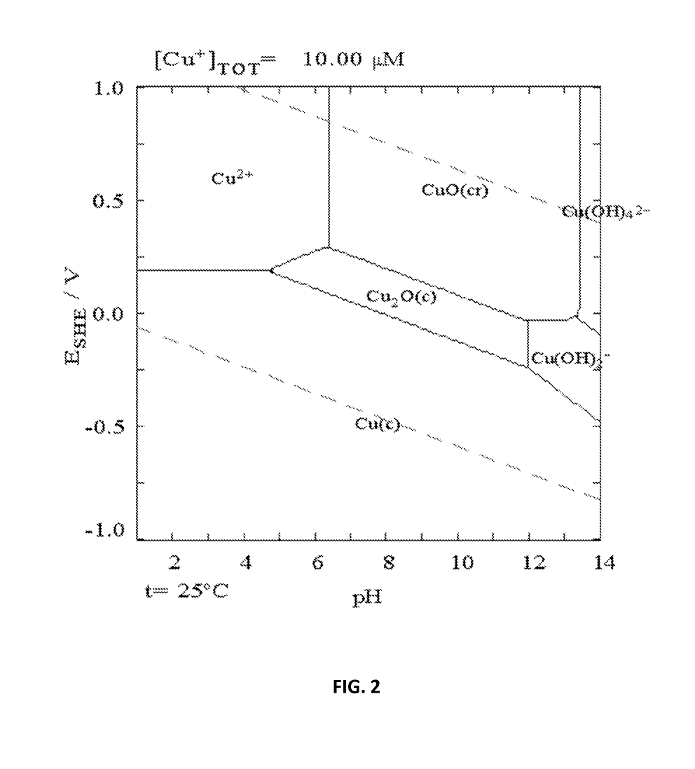

By knowing the potential and the pH of the solution that is being used during the electrochemical reaction, the oxidation state of the metal ion being deposited into solution can be controlled. To demonstrate this, a Pourbaix diagram of copper is shown in FIG. 2. The vertical axis is the reduction potential and the horizontal axis is the pH.

FIG. 2 is a thermodynamic, electron potential, versus thermodynamic, pH, depiction of speciation of copper in water at 25° C. This means by simply changing the pH and/or the potential, which of the three different oxidation states copper (0, +1, and +2) is in solution can be controlled.

When trying to exchange copper onto zeolites by traditional solution exchange, the amount of copper in solution is usually much higher than the amount of copper that is actually exchanged. Because of this, the filtrate from the isolation of the zeolite can be high in copper content, leading to disposal costs.

In contrast, in the presently described electrochemical processes, after exchange is complete, any copper remaining in solution can be recovered. This is done by changing the leads of the electrochemical cell. That is the working electrode, copper, is transformed into the auxiliary electrode and the counter electrode is transformed into the working electrode. Exemplary half reactions are shown below in equations 4 and 5.

Cathode(working electrode): 2Cu²⁺+4e⁻→Cu(s) (4)

Anode(counter electrode): 2H₂O→O₂(g)+4H⁺+4e⁻ (5)

Once the copper in solution is deposited back onto the copper electrode as copper metal, the copper is thus recycled.

According to one embodiment, a method of preparing a metal containing inorganic ion exchanger in an electrochemical cell is disclosed.

The metal in this method can be vanadium, chromium, manganese, iron, cobalt, copper, nickel, zinc, cadmium, molybdenum, ruthenium, cerium, silver, or combinations thereof.

The inorganic ion exchanger described herein can be selected from the group consisting of zeolites, molecular sieves, aluminosilicates, titanosilicates, silicoaluminophosphates (SAPOs), and mixtures thereof.

In some embodiments, the zeolites can be selected from the group consisting of zeolite X, zeolite Y, faujasite, SSZ-13, chabazite, zeolite A, ZSM-5, Beta, mordenite, Ultrastable Y, USZ-1, ferrierite, SAPO-34, and mixtures thereof.

In some embodiments, the molecular sieves can be selected from the group consisting of ETS-10, ETS-4, an ITQ molecular sieve, ITQ-1, ITQ-2, ITQ-21, ITQ-23, ITQ-39, SAPO-18, and mixtures thereof.

The inorganic ion exchanger can have a uniform pore size ranging from about 1 to about 50 Angstroms.

The method of preparing the metal containing inorganic ion exchanger in an electrochemical cell comprises the steps (a)-(f) described in detail hereinbelow:

(a) adding the inorganic ion exchanger to the electrochemical cell, wherein the electrochemical cell comprises a conductive electrolyte solution having a liquid phase and a solid phase. The conductive electrolyte solution can comprise water or other solvents that can be used for electrochemistry. The temperature of the solution varies from 15-90° C. depending on the application and need of the experiment. This can be either to help exchange of the metal ion, ion exchangers stability, and other considerations.

(b) depositing metal ions electrochemically into the liquid phase. This is done via bulk electrolysis which is explained hereinbelow.

(c) allowing the metal ions to deposit onto the inorganic ion exchanger during an electrochemical reaction to obtain a metal containing inorganic ion exchanger. This is done by varying the potential to correspond to the oxidation state and the amount of metal that is to be deposited.

(d) collecting the solid phase comprising the metal containing inorganic ion exchanger obtained in step (c). This is done after allowing it to mix for a about 0-120 minutes at a temperature of about 15-20° C.

(e) removing remaining metal ions from the liquid phase. Step (e) can comprise removing the remaining metal ions by an electrochemical method, by a precipitation method, by a complexing method, by a distillation method, or combinations thereof. Step (e) of removing remaining metal ions from the solution can comprise: (i) reversing the working electrode and the counter electrode and/or (ii) changing the pH of the solution.

(f) obtaining a substantially metal free liquid phase. In various embodiments, the substantially metal free liquid phase in step (f) comprises less than 100 ppm of metal. In some preferred embodiments, the substantially metal free liquid phase in step (f) comprises less than 10 ppm of metal. In some other preferred embodiments, the substantially metal free liquid phase in step (f) comprises less than 2 ppm of metal.

The working electrode in steps (a)-(d) can comprises the metal which is one or combinations of the ones listed hereinabove.

According to another embodiment, a catalyst comprising a metal containing inorganic ion exchanger, wherein the metal containing inorganic ion exchanger is prepared in an electrochemical cell, and wherein the method of preparing the metal containing inorganic ion exchanger is discussed hereinabove.

According to another embodiment, a method of obtaining a substantially metal free liquid phase when preparing a metal containing inorganic ion exchanger in an electrochemical cell is disclosed. The method is discussed hereinabove.

An exhaust gas treatment system comprising an exhaust gas stream containing NOx, and the above-described catalyst effective for selective catalytic reduction of at least one component of NOx in the exhaust gas stream are disclosed in some embodiments.

It will now be apparent to those skilled in the art that this specification at least describes: methods of preparing metal containing inorganic ion exchangers in electrochemical cells; methods of obtaining substantially metal free liquid phases when preparing metal containing inorganic ion exchangers in electrochemical cells; and catalysts comprising metal containing inorganic ion exchangers. It will also be apparent to those skilled in the art that numerous modifications, variations, substitutes, and equivalents exist for various aspects of the invention that have been described in the detailed description above. Accordingly, it is expressly intended that all such modifications, variations, substitutions, and equivalents that fall within the spirit and scope of the invention, as defined by the appended claims, be embraced thereby.

### EXAMPLES

### Zeolite Samples

All zeolites were made using literature procedures. The zeolites include Fe/Ce Beta (Higgins, J. B., LaPierre, R. B., Schlenker, J. L., Rohrman, A. C., Wood, J. D., Kerr, G. T. and Rohrbaugh, W. J. Zeolites, 8, 446-452 (1988)), SSZ-13 (Zones, S. I. U.S. Pat. No. 4,544,538, (1985)), and SAPO-34 (Lok, B. M., Messina, C. A., Patton, R. L., Gajek, R. T., Cannan, T. R. and Flanigen, E. M. J. Am. Chem. Soc., 106, 6092-6093 (1984)). The ammonium forms were made by standard NH₄NO₃ exchange. The hydrogen forms were made by calcining the ammonium form at 540° C. for 4 hours in flowing air.

### Example 1

### Solution Exchange

300 grams of 60% ammonium nitrate solution was added to 2700 grams of deionized (DI) water. 300 grams of calcined SSZ-13 zeolite having a silicon/aluminum ratio of about 14 was gradually added to the solution with agitation to form a slurry. The slurry was heated to 80° C. and held at this temperature with agitation for one hour. The ammonium exchanged zeolite (SSZ-13-NH₄⁺) thereby formed was filtered and washed until the conductivity of the filtrate was below 200 microohms. The SSZ-13-NH₄⁺ was dried at 90° C. for 16 hours.

11.97 grams of copper (II) acetate monohydrate containing 3.81 grams of copper was dissolved in 400 ml of deionized water with agitation at 70° C. 100 grams of the SSZ-13-NH₄⁺ described above was added to the solution. The pH of the resulting slurry was 4.6. The slurry was stirred for one hour at 70° C. The resulting copper exchanged SSZ-13 was filtered and washed with 2 liters of deionized water. The copper exchanged SSZ-13 (SSZ-13-Cu) was dried overnight at 85° C. Elemental analysis of the material by inductively coupled plasma mass spectrometry (ICP-MS) showed 1.46% copper by weight. By material balance the copper content of the SSZ-13-Cu was 1.469 grams. Only 38.6 percent of the copper in the original copper acetate solution was incorporated in the SSZ-13.

### Example 2

### Electrochemical Exchange

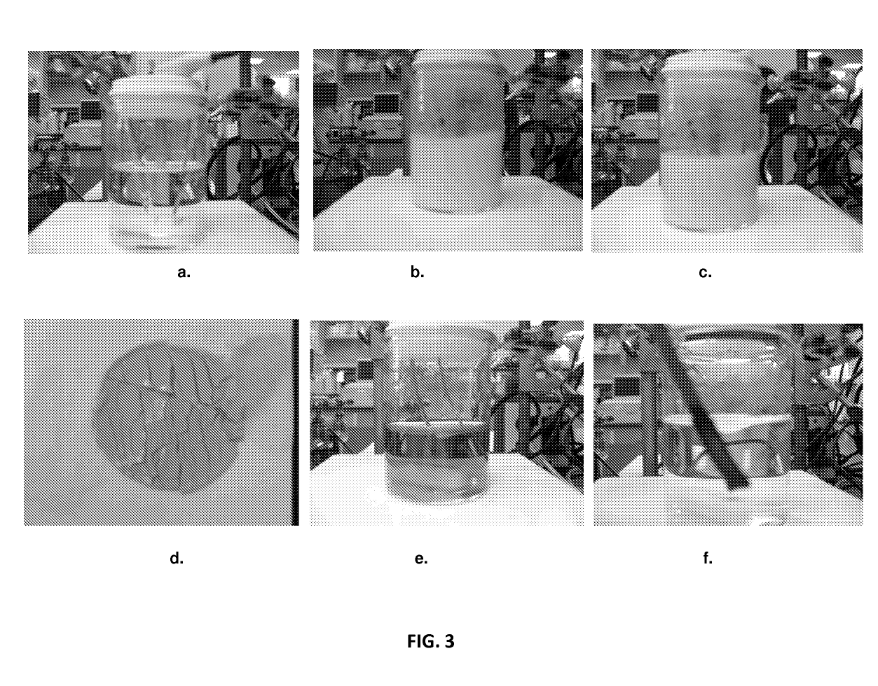

FIG. 3 shows six photographs representing the visual cycle of electrochemistry ion exchange process. An electrochemical cell was constructed that consisted of water (50 mL), an electrolyte (2 g of ammonium carbonate), and a magnetic stirrer—all shown in FIG. 3a. The counter electrode is platinum gauze (or any other metal that will not be reduced or oxidized). The working electrode is a foil (Cu) or any other metal desired to be incorporated into the zeolite or molecular sieve. Two grams of zeolite is added (either sodium, ammonium or H+ form)—shown in FIG. 3b. The pH of the zeolite slurry is adjusted to the desired level (between pH 3-9). by addition of acid or base. The temperature of the cell is varied between experiments ranging from room temperature (i.e., about 22° C.) to 85° C. The electrodes are immersed in the slurry of the molecular sieve. The electrolysis is controlled by a BASi 100 w potentiostat. The reaction is run until the desired amounts of metal ions are put into solution as determined by monitoring the increase in coulombs. This can be seen in FIG. 3c by the solution turning bluish. The bluish color is due to Cu(II) ions being deposited in solution. At the end of the reaction, the zeolite slurry is removed from the electrochemical cell and is filtered and washed leaving a bluish cake FIG. 3d. The resulting zeolite copper exchanged catalyst was dried overnight at 85° C. and analyzed for metal content. The water used to wash the copper exchanged zeolite and the electrolyte solution containing excess copper that was not taken up by the zeolite and filtered off are returned to the electrochemical cell. The leads of the cell are exchanged by making the Pt gauze the anode and the copper foil the cathode. The electrodes are then submerged into the blue solution containing Cu(II) ions in it, FIG. 3e. The potential stat is turned on and the Cu(II) ions come out of solution and onto the copper foil. This can be seen by the fact the solution is no longer blue and the copper foil had more material on it—see FIG. 3f.

### Example 3

### Taking Copper Out of Solution by Electrochemistry

A flask was charged with a stir bar, 2.0 grams of Cu(OAc)₂.H₂O, 2.0 grams of Na(OAc).3H₂O and 50 mL of DI H₂O. The mixture was stirred until all of the solids dissolved into solution. The solution became a copper blue color. 10 mL of the solution was taken for elemental analysis. A copper electrode, as the counter electrode, and a platinum electrode, as the working electrode were submerged into the solution. Bulk electrolysis was run into the solution became colorless from the blue solution. During this time it could be seen that copper metal was building up on the counter electrode. The electrolysis was run for an additional 30 minutes after that. Elemental analysis showed the starting solution had a copper concentration of 13800 ppm while after electrochemistry the copper concentration was less than 0.1 ppm. This is the detection limit of the analytical ICP-MS unit.

This experiment shows that copper can be removed from solution even if copper is not initially put in by electrochemistry. The analytical method is inductively coupled plasma mass spectrometry (ICP-MS) which is a type of mass spectrometry that is highly sensitive and capable of the determination of a range of metals and several non-metals at concentrations to 10^{th} of a part per million (0.1 ppm). It is based on coupling together an inductively coupled plasma as a method of producing ions (ionization) with a mass spectrometer as a method of separating and detecting the ions. ICP-MS is also capable of monitoring isotopic speciation for the ions of choice.

### Catalyst Evaluation

Reaction scheme for ammonia selective catalytic reduction is shown below in equation 6.

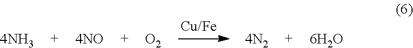

The copper or iron is exchanged onto the zeolite and reaction conditions are described below for both powder and cores samples.

All samples are first aged at 850° C. for 6 hours in 10% steam before testing except acid leached Beta. Samples were run as powders using a sample size of less than 30 mg.

### Example 4

### Catalysts Testing Methods

Initial screening was done in a microchannel reactor where the gas flow passes above the surface of the catalyst. Product and feed analysis was done by mass spectral analysis. The feed gas composition was equal parts NH₃ and NO (500 ppm), 10% O₂, and 5% H₂O (g) with helium as a carrier gas. The reactor was heated to 150° C. and stabilized for 10 minutes. The gas mixture is then introduced at rate 0.025 liters/minute/channel. The gas and temperature are held constant during the mass spectrometer analysis. The temperature is increased at a rate of 10° C./minute until 200° C. is reached and allowed to stabilize for 10 minutes again. The temperature is held constant and the gas product mixture measured again. This is repeated for temperatures: 250° C., 300° C., 350° C., 400° C., 450° C., and 500° C.

A catalyst was wash coated onto a cordierite monolith (300 cells per square inch) at a loading of 2.4 grams per cubic inch. Catalyst evaluation was accomplished using a gas-phase chemical reactor which consists of four catalyst chambers in a tube furnace, permitting evaluation of four catalysts simultaneously. These four chambers are fed by a manifold of gases delivering NO (590 ppm), NH3 (600 ppm), O2 (10%), H2O (5%), and balanced with N2. The flow rate and gas composition is set manually via a system of rotometers. The reactor inlet temperature is maintained by a gas preheater. The outlet gas is sampled to a Thermo-Nicolet™ Antaris™ Industrial Gas System (IGS) Fourier Transform Infrared (FT-IR) gas analyzer where the NH3, NO, NO2, and N2O are measured. Steady state outlet emissions are recorded manually. A typical evaluation for SCR measures four or five steady-state temperature points between 200° C. and 445° C. for each of the four catalysts being tested. All evaluations were done at a Gas Hourly Space Velocity (GHSV)=80,000/hr on monolith cores that were 3 in (7.62 cm) in length, giving a linear flow velocity of 2.11 msec. For a channel dimension of 1.27 mm and T=300° C., the Reynolds number is 9.1 for the system. This means that the reactor is operating in a strongly laminar flow regime, and the dominant mechanism for delivery of reactant molecules to the catalyst surface is Einstein-Stokes diffusion.

### Example 5

### Catalysts Testing of Electrochemically Cu Exchanged SSZ-13

The results for a number of experiments using SSZ-13 are shown in Table 1 below.

TABLE 1
Collection of Cu-SSZ-13 NH₃—NOₓ-SCR
catalysts that were made electrochemically.

| | | % NOₓ | % NOₓ |
|---|---|---|---|
| Starting form | | Conversion at | Conversion at |
| of SSZ-13 | Wt % Metals Contents^{a} | 250° C.^{b} | 450° C.^{b} |
| Na | 0.2 Cu, Na <100 ppm^{c} | 15 | 20 |
| Na | 0.4 Cu, Na <100 ppm^{c} | 30 | 50 |
| Na | 0.9Cu, Na <100 ppm^{c} | 47 | 50 |
| NH₄⁺ | 0.8 Cu | 42 | 54 |
| NH₄⁺ | 1.2 Cu | 60 | 54 |
| NH₄⁺ | 1.4 Cu | 60 | 54 |
| H | 0.8 Cu | 41 | 54 |
| H | 1.2 Cu | 61 | 54 |
| H | 1.3 Cu | 62 | 54 |

^{a}Metals content determined by Inductively Coupled Plasma (ICP).
^{b}Samples are first steam aged at 850° C. for 6 hours with 10% steam in air. The data is from the microchannel reactor.
^{c}ICP detection limit for sodium is 100 ppm. Thus no sodium was detected in the samples.

The % NOx conversion for electrochemical exchange of the ammonium form and the hydrogen form of SSZ-13 are in line with what is expected from traditional solution exchange using Cu salts. In contrast, the results starting from the sodium form zeolite are different from the traditional solution exchange. Solution exchange of sodium form (1%) SSZ-13 with copper salts has generally resulted in a residual sodium content that is too high. This high sodium content results in low activity after steaming (aging) probably due to sodium assisted loss of zeolite crystallinity at high temperatures. Thus, a prior exchange with ammonium nitrate is used to help remove sodium and to facilitate copper exchange. In contrast, it is believed that the electrochemical method is providing an in-situ ion exchange to make the ammonium form followed by copper exchange in the same solution. The source of the ammonium ion is the ammonium carbonate electrolyte. As a result, sodium is reduced to the low percentage shown in Table 1.

### Example 6

### Catalysts Core Testing of Electrochemically Cu Exchanged SSZ-13 Versus Solution Exchanged Cu SSZ-13

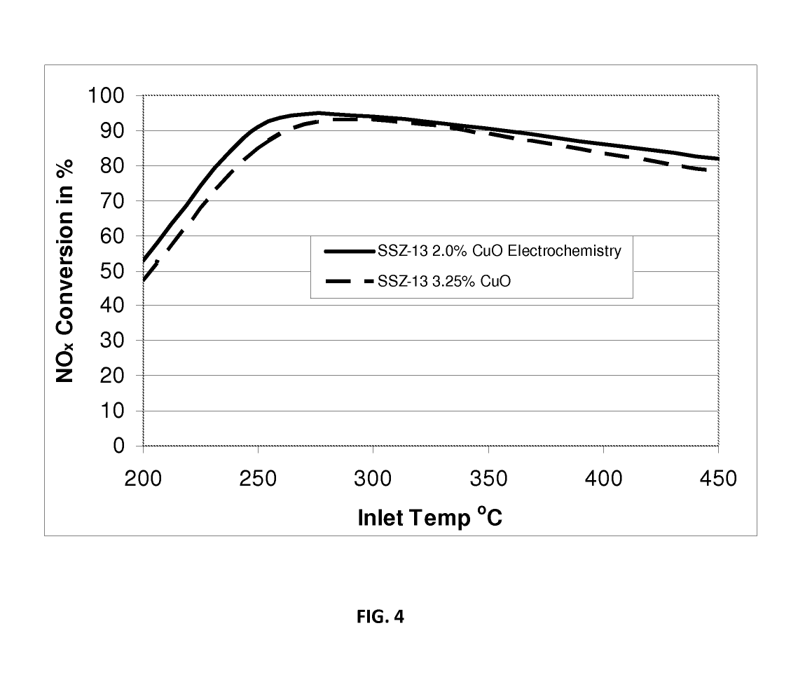

100 grams of SSZ-13 with 2% CuO loading was made by the electrochemistry method. A series of 20 five gram batches were setup to get enough material to wash coat a monolith core. The material was washcoated onto monolith cores and tested for NOₓ—NH₃ activity. As a reference, 3.25% CuO on SSZ-13 made by standard procedures for copper exchange (see FIG. 4) was used. The zeolite used for the electrochemistry and the standard is from the same batch of SSZ-13 that was made thus eliminating the possibility that the zeolites samples are of different quality.

FIG. 4 is a graphical representation of NH₃-SCR activity data generated for Cu exchanged SSZ-13 after aging with 10% steam flowing over the material at 850° C. for 6 hours. The two samples are 2.0% CuO-SSZ-13 (shown by dashed line “- - -”) made by electrochemistry and 3.25% CuO SSZ-13 (shown by solid line “—”) exchanged by the standard solution method. As shown in FIG. 4, the results show that the electrochemically copper exchanged material is as good if not better than the catalyst prepared via traditional copper exchange. By “good” in the foregoing sentence what is meant is that the activity of the two samples is within an acceptable error range.

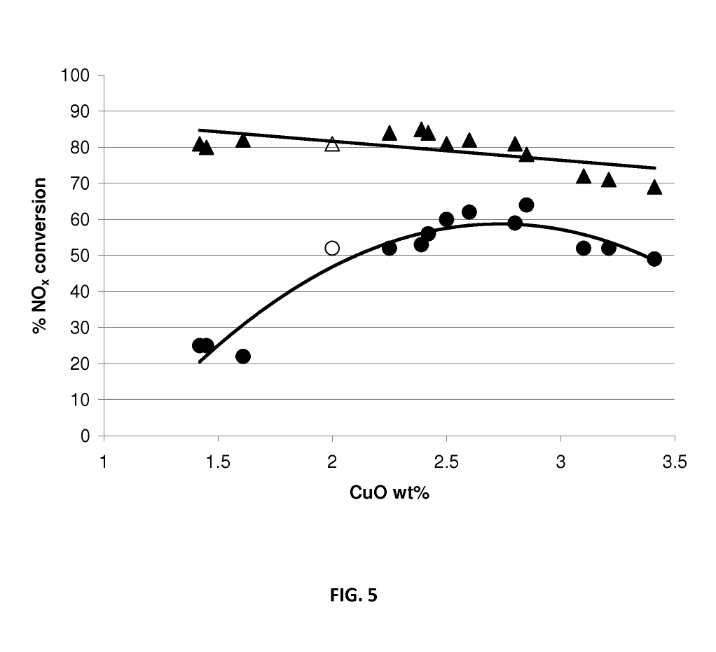

FIG. 5 is a graphical representation of NH₃-SCR activity data generated for Cu exchanged SSZ-13 after steam (10%) aging at 850° C. for 6 hours in air. The percent conversion on NOₓ at 200° C. () and 450° C. (▴) is shown for the standard ion exchange method. The sample made by the processes described herein as an open circle (◯) and open triangle for (Δ) NOx conversion at 200° C. and 450° C. respectively. The % NOₓ conversion v. the % CuO on SSZ-13 at 200° C. and 450° C. shown in FIG. 5 shows the amount of copper versus percent conversion of NOₓ at 200° C. () and 450° C. (▴) for catalysts prepared via the standard ion exchange method. It can be seen that low copper loading is better at high temperature while a higher copper loading does better at low temperatures. The sample made by the processes described herein (shown in as an open circle (◯) and open triangle for (Δ) NOx conversion at 200° C. and 450° C. respectively), follows this pattern, but it is a slightly better than the curve would expect. This is also seen in FIG. 4. The 2.0% CuO-SSZ-13 made by the processes described herein is better at converting NOₓ than 3.25% CuO-SSZ-13 made by standard exchange at 200° C. and 450° C. This demonstrates that electrochemistry is a viable way to get copper onto SSZ-13.

Electrochemistry (i.e., the processes described herein) can be used to effectively exchange Cu to SSZ-13 into all three forms (sodium, hydrogen, or ammonium) of SSZ-13. The catalytic activities of Cu catalysts prepared by the electrochemical method are comparable to that observed from traditional solution ion exchange. One of the advantages of electrochemistry is that the zeolite does not need to be initial ammonium exchange, to get the sodium level low enough, before it can be copper exchanged.

### Example 7

### Catalysts Testing of Electrochemically Cu Exchanged SAPO-34

SAPO-34 can potentially be used as a —NH₃-SCR catalyst. It was found that as is the case with Cu-SSZ-13, SAPO-34 with copper deposited by electrochemistry has comparable activity to Cu SAPO-34 prepared by traditional solution exchange (see Table 2 hereinbelow). Once again the amount of copper needed to achieve the same activity is lower than that of standard preparation procedures. Furthermore, the SAPO-34 did not have to be ammonium exchanged to get the copper into the frame work. That is, the activity of the hydrogen and the ammonium forms are comparable after copper was added to them. In the normal Cu-SAPO-34 preparation the SAPO-34 first has to be ammonium exchanged even though there is no sodium in the synthesis. As a control, the last row in Table 2 is a standard copper exchange on the ammonium form of SAPO-34.

TABLE 2
Collection of Cu-SAPO-34 NH₃—NOₓ-SCR
catalysts that were made electrochemically.

| | | % NOₓ | % NOₓ |
|---|---|---|---|
| Starting form | | Conversion at | Conversion at |
| of SAPO-34 | Wt % Cu Content^{a} | 250° C.^{b} | 450° C.^{b} |
| H | 0.3 | 47 | 60 |
| H | 0.65 | 55 | 60 |
| H | 0.93 | 52 | 57 |
| NH₄⁺ | 0.4 | 32 | 32 |
| NH₄⁺ | 0.7 | 40 | 54 |
| NH₄⁺ | 0.9 | 41 | 60 |
| (NH₄⁺)^{c} | 1.68 | 62 | 62 |

^{a}Metals content determined by ICP.
^{b}Samples are first steam aged at 850° C. for 6 hours with 10% steam in air. The data is from the microchannel reactor.
^{c}As a control this is a standard solution exchange Cu-SAPO-34.

### Example 8

### Catalysts Testing of Electrochemically Fe Exchanged

To expand on the electrochemistry, iron was deposited onto SAPO-34 electrochemically. The same procedures were used as in the copper electrochemistry except iron foil was substituted for copper foil. As expected, the iron exchanged materials are not as good catalytically as the copper (see Table 3 hereinbelow). A Fe/Ce-Beta standard is in Table 3 hereinbelow as a reference. The standard, Fe/Ce-Beta was not aged because it could not withstand 850° C. steam ageing.

TABLE 3
Collection of Fe-SAPO-34 NH₃—NOₓ-SCR
catalysts that were made electrochemically.

| | | % NOₓ | % NOₓ |
|---|---|---|---|
| Starting form | | Conversion at | Conversion at |
| of SAPO-34 | Wt % Metals Content^{a} | 250° C.^{b} | 450° C.^{b} |
| H | 0.42 Fe | 14 | 40 |
| H | 1.51 Fe | 40 | 54 |
| H | 2.05 Fe | 34 | 57 |
| NH₄⁺ | 0.4 Fe | 15 | 54 |
| NH₄⁺ | 3.2 Fe | 34 | 60 |
| NH₄⁺ | 5.0 Fe | 33 | 60 |
| Fe/Ce-Beta^{C} | 0.73 Fe | 25 | 55 |

^{a}Metals content determined by ICP.
^{b}Samples are first steam aged at 850° C. for 6 hours with 10% steam in air. The data is from the microchannel reactor.
^{c}This is fresh Fe/Ce Beta that was not aged because it would be completely deactivated at this ageing protocol that is described in b hereinabove.

The above shows iron-containing zeolites that have NOₓ—NH₃-SCR activity and can withstand 850° C. steams ageing for 6 hours.

For both SSZ-13 and SAPO-34, copper can be electrochemically exchanged into the sieve. The resulting catalyst was found to have good catalytic activity. The copper content was not optimized. In both cases, the zeolites did not have to be initial ammonium exchanged to be able to incorporate copper into the zeolites. As expected, Fe SAPO-34 was not as active for NH₃ SCR as the copper form.

### Example 9

### Catalysts Testing of Electrochemically Fe Exchanged Beta

Iron was exchanged into two different forms of Beta zeolite using the same procedures discussed hereinabove pertaining to the exchange process used in the SAPO-34 example, except with different ion-exchange forms of Beta (see Table 4 hereinbelow). The resulting iron catalyst starting from the hydrogen form is similar to the iron catalyst resulting from the cerium form. These results demonstrate that iron can be exchanged into beta zeolites electrochemically without a drop in performance compared to traditional iron exchanged Beta zeolites.

TABLE 4
Collection of Fe-Beta NH₃—NOₓ-SCR catalysts
that were made electrochemically.

| | | % NOₓ | % NOₓ |
|---|---|---|---|
| Starting form | | Conversion at | Conversion at |
| of Beta | Wt % Metals Content^{a} | 250° C.^{b} | 450° C.^{b} |
| H | 0.40 Fe | 10 | 45 |
| H | 0.81 Fe | 15 | 41 |
| Ce | 0.40 Fe | 5 | 50 |
| Ce | 0.97 Fe | 10 | 43 |
| Fe/Ce-Beta^{C} | 0.7 Fe | 25 | 55 |

^{a}Metals content determined by ICP.
^{b}Samples are only calcined at 540° C. The data is from the microchannel reactor.
^{c}This is fresh Fe/Ce Beta that was not aged because it would be deactivated at this ageing protocol.

Iron can be deposited in two different states—Fe (+1 and +2). The foregoing can be accomplished by controlling the pH and the potential that is applied during the electrolysis. This can be seen visually by noting the color of the iron while it is depositing. When iron is deposited into the solution in the Fe(I) state the solution is bluish and slowly turns to a rust color over a period of time (about 15 minutes). Furthermore, the top of the reaction, which is in contact with air, is a rust color. This is important because in the case that Fe(I) exchanges better than Fe(II) we can use electrochemistry methods to accomplish the exchange. It is difficult to buy and maintain Fe(I) on a commercial scale. It is difficult because Fe(I) is rapidly oxidized by air at room temperature. Oxidation of iron can be avoided by bubbling the solution with nitrogen and/or degassing the solution of oxygen during the reaction. Thus, Fe(I) can be maintained in solution on a large scale cheaply and effectively.

Iron was exchanged onto beta zeolites via electrochemistry. The resulting catalyst had performance in the NH₃ SCR reaction as good as the material that was made by standard ion exchange methods. An additional benefit for using electrochemistry is that the oxidation state of iron can be controlled by just changing the potential. This use of an unstable Fe(I) compound on a large scale is difficult, but can be easily done by using electrochemistry. The solution needs to be spurged with an inert gas get rid of the oxygen and the Fe(I) can be deposited without quickly being oxidize to Fe(II/III).

The examples hereinabove show that the processes of this disclosure (i.e., electrochemistry methods) have been used to deposit metals into zeolites and porous material. The initial reasoning for this was to lower the cost of putting copper into zeolites. Another added benefit is that an initial exchange to get the zeolites in the right form before ion exchange is not necessary. That saves time and money because traditionally zeolites like SSZ-13 first have to be ion exchanged to reduce the amount of sodium so there can be an effective copper exchange. Electrochemistry does this all in one electrochemical cell and one step. Sufficient quantities of Cu-SSZ-13 have been made by electrochemistry to coat honeycombs cores and the performances of the coated honeycombs has been tested. As shown hereinabove, the performance of the coated honeycombs is as good if not better than standard ion exchange methods.

The present invention has been described by way of the foregoing exemplary embodiments to which it is not limited. Variations and modifications will occur to those skilled in the art that do not depart from the scope of the invention as recited in the claims appended thereto.

1. A method of preparing a metal containing inorganic ion exchanger in an electrochemical cell, the method comprising:
(a) adding the inorganic ion exchanger to the electrochemical cell, wherein the electrochemical cell comprises a conductive electrolyte solution having a liquid phase and a solid phase;
(b) depositing metal ions electrochemically into the liquid phase;
(c) allowing the metal ions to deposit onto the inorganic ion exchanger during an electrochemical reaction to obtain a metal containing inorganic ion exchanger;
(d) collecting the solid phase comprising the metal containing inorganic ion exchanger obtained in step (c);
(e) removing remaining metal ions from the liquid phase; and
(f) obtaining a substantially metal free liquid phase.

2. The method of claim 1, wherein step (e) comprises removing the remaining metal ions by an electrochemical method, by a precipitation method, by a complexing method, by a distillation method, or combinations thereof.

3. The method of claim 1, wherein step (e) of removing remaining metal ions from the solution comprises:
(i) reversing the working electrode and the counter electrode and/or
(ii) changing the pH of the solution.

4. The method of claim 1, wherein the metal is vanadium, chromium, manganese, iron, cobalt, copper, nickel, zinc, cadmium, molybdenum, ruthenium, cerium, silver, or combinations thereof.

5. The method of claim 1, wherein the working electrode in steps (a)-(d) comprises the metal.

6. The method of claim 1, wherein the inorganic ion exchanger is selected from the group consisting of zeolites, molecular sieves, aluminosilicates, titanosilicates, silicoaluminophosphates (SAPOs), and mixtures thereof.

7. The method of claim 1, wherein the zeolites are selected from the group consisting of zeolite X, zeolite Y, faujasite, SSZ-13, chabazite, zeolite A, ZSM-5, Beta, mordenite, Ultrastable Y, USZ-1, ferrierite, SAPO-34, and mixtures thereof.

8. The method of claim 1, wherein the molecular sieves are selected from the group consisting of ETS-10, ETS-4, an ITQ molecular sieve, ITQ-1, ITQ-2, ITQ-21, ITQ-23, ITQ-39, SAPO-18, and mixtures thereof.

9. The method of claim 1, wherein the inorganic ion exchanger has a uniform pore size ranging from about 1 to about 50 Angstroms.

10. The method of claim 1, wherein the solution comprises water.

11. The method of claim 1, wherein the substantially metal free liquid phase in step (f) comprises less than 100 ppm of metal.

12. The method of claim 11, wherein the substantially metal free liquid phase in step (f) comprises less than 10 ppm of metal.

13. The method of claim 12, wherein the substantially metal free liquid phase in step (f) comprises less than 2 ppm of metal.

14. A catalyst comprising the metal containing inorganic ion exchanger of claim 1.

15. A method of obtaining a substantially metal free liquid phase when preparing a metal containing inorganic ion exchanger in an electrochemical cell, the method comprising:
(a) adding the inorganic ion exchanger to the electrochemical cell, wherein the electrochemical cell comprises a conductive electrolyte solution having a liquid phase and a solid phase;
(b) depositing metal ions electrochemically into the liquid phase;
(c) allowing the metal ions to deposit onto the inorganic ion exchanger during an electrochemical reaction to obtain metal containing inorganic ion exchanger;
(d) collecting the solid phase comprising the metal containing inorganic ion exchanger obtained in step (c);
(e) removing remaining metal ions from the liquid phase; and
(f) obtaining a substantially metal free liquid phase.

16. The method of claim 15, wherein step (e) comprises removing the remaining metal ions by an electrochemical method, by a precipitation method, by a complexing method, by a distillation method, or combinations thereof.

17. The method of claim 15, wherein step (e) of removing remaining metal ions from the solution comprises:
(i) reversing the working electrode and the counter electrode and/or
(ii) changing the pH of the solution.

18. The method of claim 15, wherein the metal is vanadium, chromium, manganese, iron, cobalt, copper, nickel, zinc, cadmium, molybdenum, ruthenium, cerium, silver, or combinations thereof.

19. The method of claim 15, wherein the working electrode in steps (a)-(d) comprises the metal.

20. The method of claim 15, wherein the inorganic ion exchanger is selected from the group consisting of zeolites, aluminosilicates, titanosilicates, and mixtures thereof.

21. The method of claim 15, wherein the zeolites are selected from the group consisting of zeolite X, zeolite Y, faujasite, SSZ-13, chabazite, zeolite A, ZSM-5, Beta, mordenite, Ultrastable Y, USZ-1, ferrierite, SAPO-34, and mixtures thereof.

22. The method of claim 15, wherein the molecular sieves are selected from the group consisting of ETS-10, ETS-4, an ITQ molecular sieve, ITQ-1, ITQ-2, ITQ-21, ITQ-23, ITQ-39, SAPO-18 and mixtures thereof.

23. The method of claim 15, wherein the inorganic ion exchanger has a uniform pore size ranging from about 1 to about 50 Angstroms.

24. The method of claim 15, wherein the solution comprises water.

25. The method of claim 15, wherein the substantially metal free liquid phase in step (f) comprises less than 100 ppm of metal.

26. The method of claim 25, wherein the substantially metal free liquid phase in step (f) comprises less than 10 ppm of metal.

27. The method of claim 26, wherein the substantially metal free liquid phase in step (f) comprises less than 2 ppm of metal.

28. A catalyst comprising a metal containing inorganic ion exchanger, wherein the metal containing inorganic ion exchanger is prepared in an electrochemical cell, and wherein the method of preparing the metal containing inorganic ion exchanger comprises:
(a) adding the inorganic ion exchanger to the electrochemical cell, wherein the electrochemical cell comprises a conductive electrolyte solution having a liquid phase and a solid phase;
(b) depositing metal ions electrochemically into the liquid phase;
(c) allowing the metal ions to deposit onto the inorganic ion exchanger during an electrochemical reaction to obtain metal containing inorganic ion exchanger;
(d) collecting the solid phase comprising the metal containing inorganic ion exchanger obtained in step (c);
(e) removing remaining metal ions from the liquid phase; and
(f) obtaining a substantially metal free liquid phase.

29. An exhaust gas treatment system comprising an exhaust gas stream containing NOx, and a catalyst in accordance with claim 28 effective for selective catalytic reduction of at least one component of NOx in the exhaust gas stream.
